(19) United States
(12) Patent Application Publication
(10) Pub. No.: US 2010/0018123 A1
(43) Pub. Date: Jan. 28, 2010

(54) SLIDING FENESTRATION ASSEMBLY WITH LINEAL TILT LATCH ACTUATOR

(75) Inventor: Leslie B. Hendrickson, Roseau, MN (US)

Correspondence Address: SCHWEGMAN, LUNDBERG & WOESSNER, P.A., P.O. BOX 2938, MINNEAPOLIS, MN, 55402, US

(73) Assignee: Marvin Lumber and Cedar Company, d/b/a Marvine Windows and Doors, Warroad, MN (US)

(21) Appl. No.: 12/433,319

(22) Filed: Apr. 30, 2009

Related U.S. Application Data
(60) Provisional application No. 61/049,280, filed on Apr. 30, 2008.

(51) Int. Cl. E05D 15/06; E06B 3/00

(52) U.S. Cl. 49/176; 49/506

(57) ABSTRACT

A fenestration assembly including a sash slidingly movable with respect to a frame. The sash includes an at least one elongate lineal tilt latch actuator that has a first position and a second position. In the first position, the at least one elongate lineal tilt latch actuator is disposed within a channel of the frame and partially extended from the channel. In the second position, the at least one elongate lineal tilt latch actuator is at least partially retracted within the sash allowing for the sash to be tilted relative to the frame.

### CROSS-REFERENCE TO RELATED APPLICATION

This application claims the priority of U.S. Ser. No. 61/049,280, filed Apr. 30, 2008, which is incorporated herein by reference in its entirety.

### TECHNICAL FIELD

The present disclosure relates to sliding fenestration assemblies with a lineal tilt latch actuator.

### TECHNICAL BACKGROUND

Exterior fenestration units, such as sliding glass windows are typically mounted in building walls to provide a view to the exterior of the building. The windows also provide a barrier against weather including wind and rain. The windows must be able to withstand a certain amount of pressure from weather including wind, yet remain operable for users.

### SUMMARY

A fenestration assembly includes a frame having at least one channel therein, and at least one sash slidable relative to and within the frame. The at least one sash has at least one sash channel therein, and at least one elongate lineal tilt latch actuator is slidably disposed within the sash channel. The at least one elongate lineal tilt latch actuator movable from a first position to a second position. In the first position, the at least one elongate lineal tilt latch actuator is disposed and slidable within the channel of the frame. In the second position, the at least one elongate lineal tilt latch actuator is partially recessed within the sash channel and allowing the sash to tilt relative to the frame.

In another option, a method includes moving a sash within a frame, including sliding the sash within the frame, where the frame has at least one channel, and the sash includes a sash channel. The sash further includes a lineal tilt latch actuator having a first position and a second position. The method further includes moving the elongate lineal tilt latch actuator from the first position to the second position. In the first position, the elongate lineal tilt latch actuator is disposed and slidable within the channel. In the second position, the elongate lineal tilt latch actuator is partially recessed within the sash channel and allowing the sash to tilt relative to the frame.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### BRIEF DESCRIPTION OF THE DRAWINGS

FIG. 1 is a perspective view of a window assembly as constructed in accordance with at least one embodiment.

FIG. 2 is a perspective view of a portion of a window sash as constructed in accordance with at least one embodiment.

FIG. 3A is a perspective view of an elongate lineal tilt latch actuator as constructed in accordance with at least one embodiment.

FIG. 3B is a perspective view of a portion of an elongate lineal tilt latch actuator as constructed in accordance with at least one embodiment.

FIG. 4 is a cross-sectional view of a window assembly taken along 4-4 of FIG. 5 as constructed in accordance with at least one embodiment.

FIG. 5 is an exploded perspective view of a window assembly constructed in accordance with at least one embodiment.

FIG. 6 is a perspective view of a portion of a sash as constructed in accordance with at least one embodiment.

FIG. 7 is a perspective view of a portion of a sash as constructed in accordance with at least one embodiment.

FIG. 8 is a perspective view of a portion of a sash as constructed in accordance with at least one embodiment.

FIG. 9 is an exploded perspective view of a portion of a sash as constructed in accordance with at least one embodiment.

FIG. 10 is a perspective view of a portion of a sash as constructed in accordance with at least one embodiment.

FIG. 11 is a side view of an elongate lineal tilt latch actuator as constructed in accordance with at least one embodiment.

FIG. 12 is a bottom view of an elongate lineal tilt latch actuator as constructed in accordance with at least one embodiment.

### DESCRIPTION OF THE EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope is defined by the appended claims and their equivalents.

The embodiments relate to a tilt latch actuator for a fenestration assembly such as an operable door or window. For example, an operable window that has one or more operable panels, that can move from a closed position to an open position relative to a stationary panel.

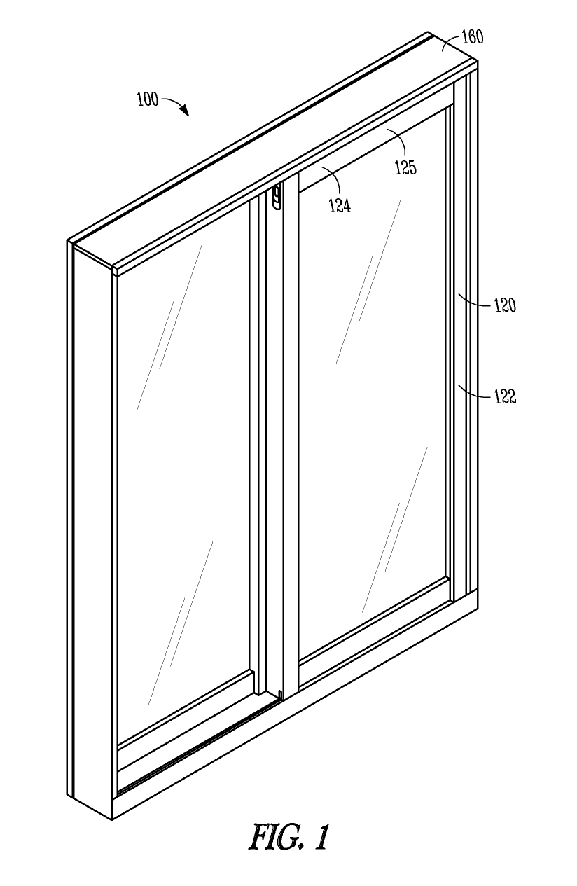

FIG. 1 illustrates a fenestration assembly such as a window assembly 100. Although the discussion herein relates to a window assembly 100, it should be noted that the elongate lineal tilt latch actuator can be incorporated with other units such as, but not limited to, sliding windows, double hung windows, casement windows, sliding doors, etc., without departing from the scope of the application. The elongate lineal tilt latch actuator 130 assists in tilting a sash 120 relative to a frame while stabilizing a sash relative to the frame during times of high pressure to the sash.

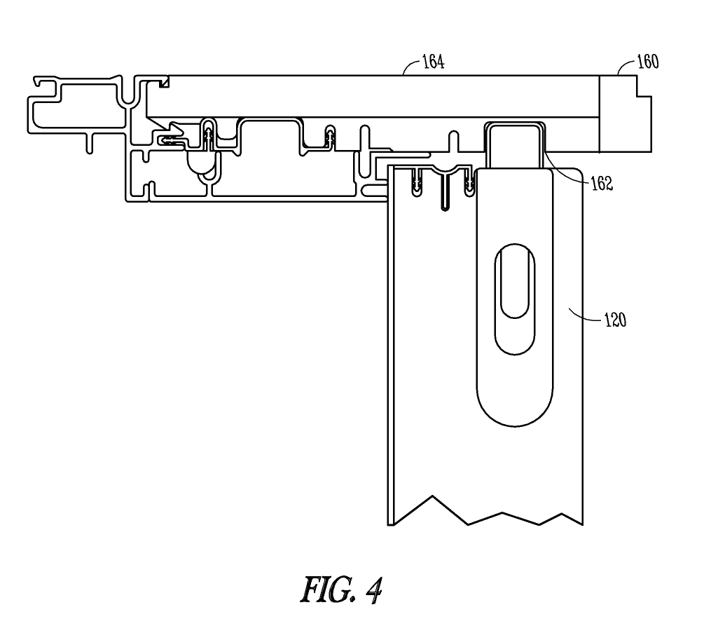

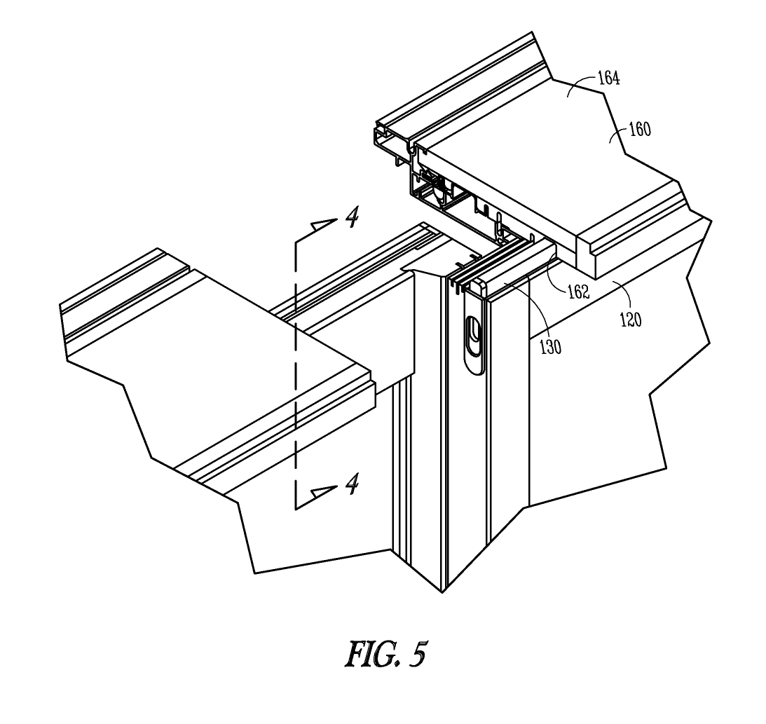

The window assembly 100, in one option, includes a frame 160, and at least one sash 120, as shown in FIGS. 4 and 5. The frame 160 is secured within a rough opening of a building, and the sash moves relative the frame 160. The frame 160 has at least one channel 162 therein. In an option, the channel 162 is disposed within an upper horizontal member 164 of the frame 160.

The at least one sash 120 includes, in an option, a first side sash and a second side sash, where the first side sash is typically slid relative to the second side sash from side to side, such as a gliding window. The window sash 120 is defined in part by an interior portion and an exterior portion, and is further defined by vertical stiles 122 and horizontal members 124, including a rail 125. In an option, the window sash 120 includes at least one locking feature. The locking features allow for the window sash to be locked to, for example, the other sash of a sliding window unit.

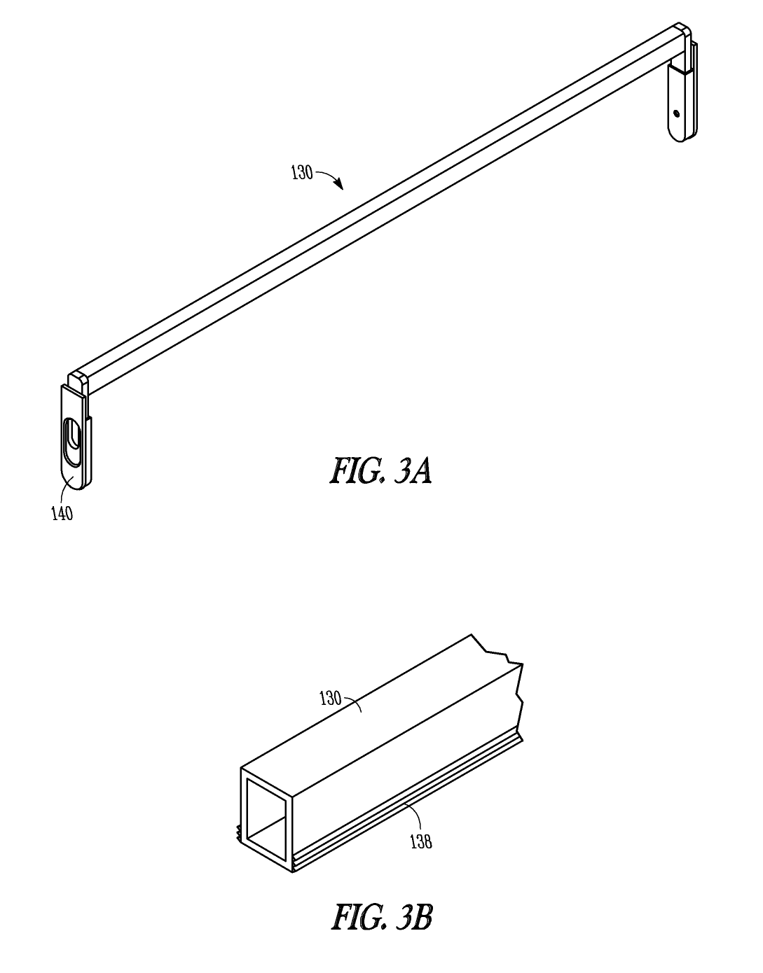

The window sash 120 includes, in one option, an elongate lineal tilt latch actuator 130, that allows for the sash to be tilted relative to the frame. The elongate lineal tilt latch actuator 130 can be disposed in one of the sashes 130, or in multiple sashes 130, such that each sash would include the elongate lineal tilt latch actuator 130. The elongate lineal tilt latch actuator 130 allows for the window sash 120 to be slid within the window frame, and also allows the sash 120 to tilt relative to the frame. The actuator guides the sash within the window frame, and are retractable within the sash, allowing for the sash to be removed or tilted away from the window frame. In an option, the actuator is an elongate bar which is received by a housing 140. In a further option, the actuator includes one or more end portions which are substantially transverse to the bar, where the end portions are slidably received within a housing, as shown in FIG. 3A.

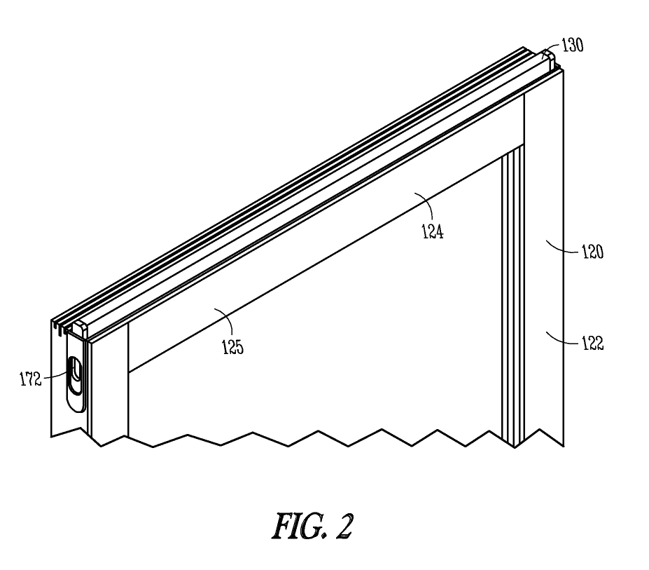

FIGS. 2, 3A, 3B, 4, 5 and 6 illustrate additional details and additional options. The window sash 120 has the elongate lineal tilt latch actuator 130 therein. The elongate lineal tilt latch actuator 130 is disposed within a sash channel 132, for instance is movably disposed within the sash channel 132, where the elongate lineal tilt latch actuator 130 can move from a first position to a second position, and from the second position to the first position. The elongate lineal tilt latch actuator 130 is partially disposed within the sash channel 132 when the elongate lineal tilt latch actuator 130 is in the first position. In the first position, a portion of the elongate lineal tilt latch actuator 130 extends out of the sash channel 132, where the extended portion of the elongate lineal tilt latch actuator 130 allows for the sash to travel within the jamb, and further allows for retention of the sash.

Although in the examples the sash channel 132 is shown in the rail of the sash 120, the sash channel 132 and the elongate lineal tilt latch actuator 130 can be disposed in the stile of the sash 120, for example, for a double hung window. In another option, the elongate lineal tilt latch actuator 130 can be disposed in the frame 160, and the channel can be disposed in the sash 120. In an option, the elongate lineal tilt latch actuator 130 is carried by a tilt latch carrier 134, as shown in FIG. 9, where the tilt latch carrier 134 is disposed and secured within the sash channel 132.

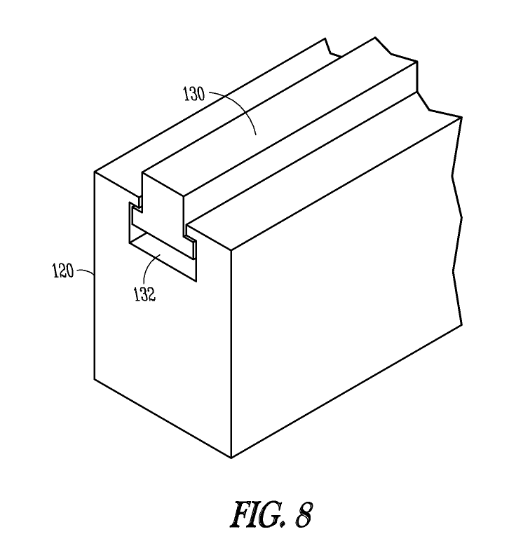

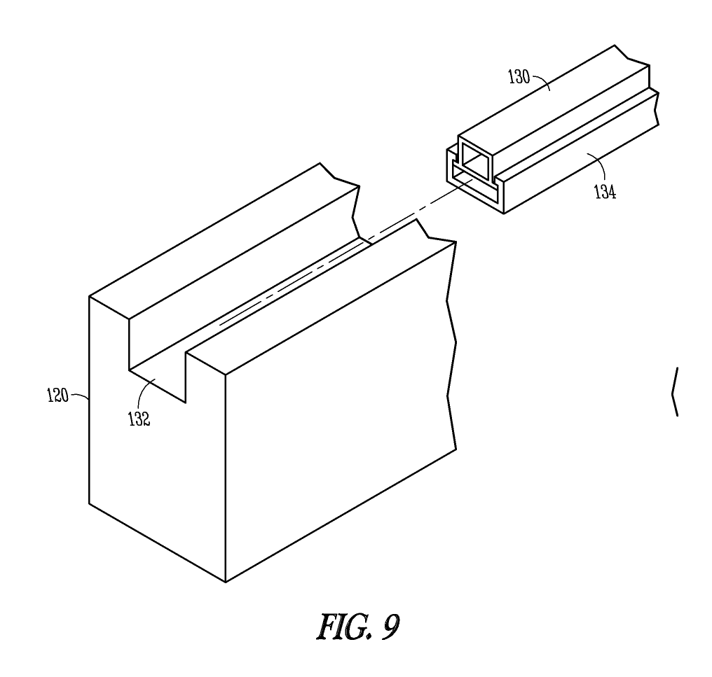

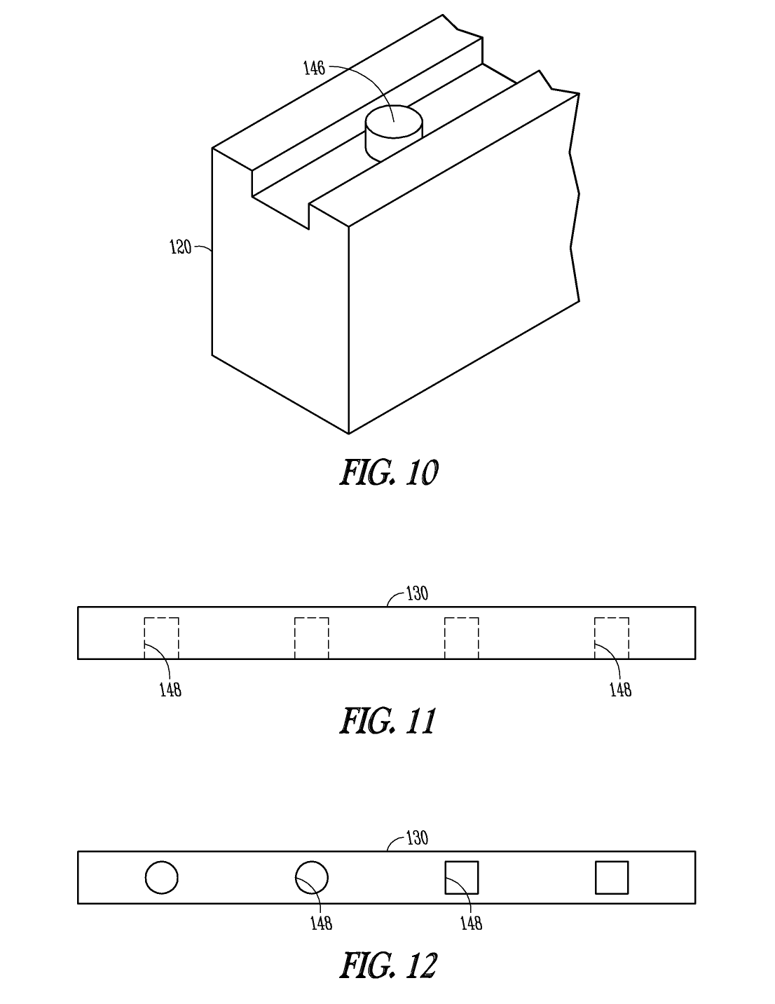

The elongate lineal tilt latch actuator 130 has an elongate, lineal shape, for instance, and can be extruded into a variety of lengths. In an option, the at least one elongate lineal tilt latch actuator has a length substantially equal to a width of the sash, providing stability. In another option, the elongate lineal tilt latch actuator 130 has a length of about 6 inches-36 inches, which provides stability yet allows for the actuator to be used with a variety of sizes of windows. In yet another option, the elongate lineal tilt latch actuator 130 is greater than about 4 inches. In an option, the elongate lineal tilt latch actuator 130 has a generally square or rectangular cross-section. In another option, the elongate lineal tilt latch actuator 130 has one or more flanges extending from side portions of the elongate lineal tilt latch actuator 130. For instance, the elongate lineal tilt latch actuator 130 has, in an option, a generally T-shaped cross section, as shown in FIGS. 8 and 9. The side extending edges can be captured by portions of the sash channel 132, and/or the tilt latch carrier 134. In yet another option, the elongate lineal tilt latch actuator 130 includes one or more projections such as teeth 138, as shown in FIG. 3B. The teeth 138 allow for the elongate lineal tilt latch actuator 130 to grab portions of the sash within the sash channel 132 when the sash 120 is under pressure.

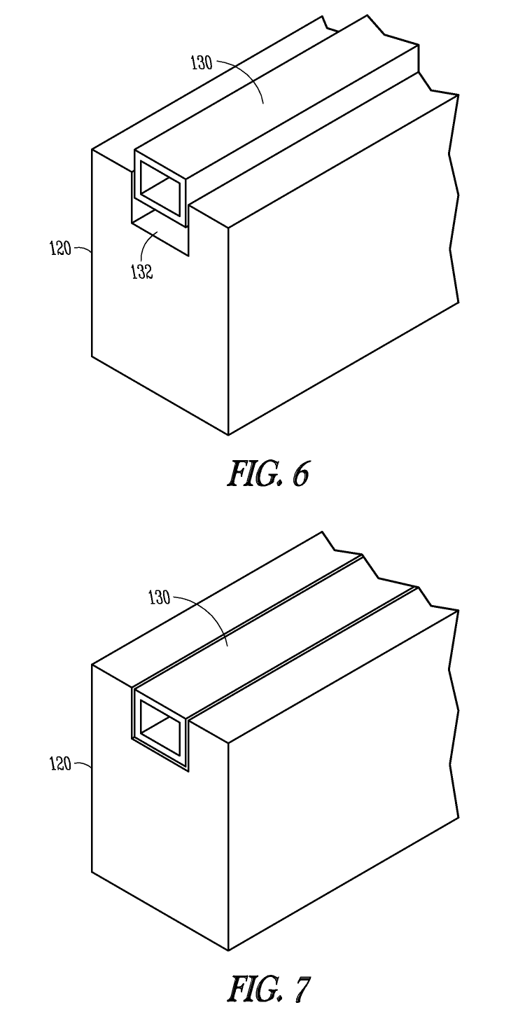

The elongate lineal tilt latch actuator 130 is movably disposed in a housing 140 (FIG. 3A), allowing for the elongate lineal tilt latch actuator 130 to move from a first position (FIGS. 2, 4, 5, and 6) to a second position (FIG. 7). In another option, the elongate lineal tilt latch actuator 130 moves from the first position to the second position via a post and recess. For instance, a post 146 can be secured within the sash channel 132 where the post mates with a recess 148 within the elongate lineal tilt latch actuator 130. The post 146 and recess 148 can have a variety of shapes such as, but not limited to, square or circular. The post 146 and recess can be switched so that the recess is within the sash channel 132 and the post 146 on the elongate lineal tilt latch actuator 130.

In the first position (FIGS. 2, 4, 5, 6), the at least one elongate lineal tilt latch actuator 130 is disposed and slidable within the channel 162 of the frame 160. In the second position (FIG. 7), the at least one elongate lineal tilt latch actuator 130 is partially recessed within the sash channel and allowing the sash to tilt relative to the frame.

A method for using the window assembly is described herein. In an option, the method includes moving a sash within a frame, including sliding the sash within the frame. The frame has at least one channel therein, and the at least one sash has at least one sash channel therein, as further described above.

The method further includes moving the elongate lineal tilt latch actuator from a first position to a second position, where in the first position the at least one elongate lineal tilt latch actuator is disposed within the channel, and in the second position the at least one elongate lineal tilt latch actuator is partially recessed within the sash channel and allowing the sash to tilt relative to the frame. The at least one elongate lineal tilt latch actuator, in an option, moves along a plane that is parallel with a main plane of the sash, or a glass pane within the sash. In an option, the elongate lineal tilt latch actuator is moved by a user, for instance, with one or more finger slots 172 (FIG. 2), or a projection operatively associated with the elongate lineal tit latch actuator. The actuator is retracted so that the sash can be tilted or removed, for example, from the frame.

Further options for the method include engaging one or more projections within the sash channel, and/or sliding the at least one elongate lineal tilt latch actuator along one or more projections. For instance, the projections can assist in grabbing the channel and preventing movement of the sash. In yet another option, the method includes sealing the sash relative to the frame with the at least one elongate lineal tilt latch actuator. In a further option, the method includes, where the elongate lineal tilt latch actuator includes a projection, engaging a catch of the channel with the projection when the elongate lineal tilt latch actuator is in the first position.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present application. The scope of the invention should, therefore, be determined with reference to the appended claims, along with the full scope of equivalents to which such claims are entitled.

What is claimed is:

1. A fenestration assembly comprising:
a frame having at least one channel therein;
at least one sash slidable relative to and within the frame, the at least one sash having at least one sash channel therein;
the at least one sash including at least one elongate lineal tilt latch actuator movable from a first position to a second position, in the first position the at least one elongate lineal tilt latch actuator is disposed and slidable within the channel, in the second position the at least one elongate lineal tilt latch actuator partially recessed within the sash channel and allowing the sash to tilt out relative to the frame.

2. The fenestration assembly as recited in claim 1, wherein the sash includes a rail, and the at least one elongate lineal tilt latch actuator is disposed in the rail.

3. The fenestration assembly as recited in claim 1, wherein the at least one elongate lineal tilt latch actuator further includes one or more projections.

4. The fenestration assembly as recited in claim 1, further comprising a tilt latch carrier, the tilt latch carrier disposed within the sash channel.

5. The fenestration assembly as recited in claim 1, wherein a cross section of the at least one elongate lineal tilt latch actuator has a T shape.

6. The fenestration assembly as recited in claim 1, wherein the at least one elongate lineal tilt latch actuator slides along a projection as the at least one elongate lineal tilt latch actuator moves from the first position to the second position.

7. The fenestration assembly as recited in claim 6, wherein the projection is disposed within the sash channel.

8. A fenestration assembly comprising:
a frame having at least one channel therein;
at least one sash slidable relative and within the frame, the at least one sash having at least one sash channel therein;
the at least one sash including at least one elongate lineal tilt latch actuator having a first position and a second position, in the first position the at least one elongate lineal tilt latch actuator is disposed and slidable within the channel, in the second position the at least one elongate lineal tilt latch actuator partially recessed within the sash channel and allowing the sash to tilt relative to the frame; and
the at least one elongate lineal tilt latch actuator has a length substantially similar to a width of the sash.

9. The fenestration assembly as recited in claim 8, wherein the sash includes a rail, and the at least one elongate lineal tilt latch actuator is disposed in the rail.

10. The fenestration assembly as recited in claim 8, wherein the at least one elongate lineal tilt latch actuator further includes one or more projections.

11. The fenestration assembly as recited in claim 8, further comprising a tilt latch carrier, the tilt latch carrier disposed within the sash channel.

12. The fenestration assembly as recited in claim 8, wherein a cross section of the at least one elongate lineal tilt latch actuator has a T shape.

13. The fenestration assembly as recited in claim 8, wherein the at least one elongate lineal tilt latch actuator slides along a projection as the at least one elongate lineal tilt latch actuator moves from the first position to the second position.

14. The fenestration assembly as recited in claim 13, wherein the projection is disposed within the sash channel.

15. A method comprising:
moving a sash within a frame, including sliding the sash within the frame, the frame having at least one channel therein, the at least one sash having at least one sash channel therein, the at least one sash including at least one elongate lineal tilt latch actuator having a first position and a second position;
moving the at least one elongate lineal tilt latch actuator from the first position to the second position, in the first position the at least one elongate lineal tilt latch actuator is disposed and slidable within the channel, in the second position the at least one elongate lineal tilt latch actuator partially recessed within the sash channel and allowing the sash to tilt relative to the frame.

16. The method as recited in claim 15, wherein the at least one elongate lineal tilt latch actuator has a length substantially similar to a width of the sash.

17. The method as recited in claim 15, wherein the elongate lineal tilt latch actuator includes a projection, engaging a catch of the channel with the projection when the elongate lineal tilt latch actuator is in the first position.

18. The method recited in claim 15, further comprising engaging one or more projections within the sash channel.

19. The method recited in claim 15, further comprising sliding the at least one elongate lineal tilt latch actuator along one or more projections.

20. The method recited in claim 15, further comprising sealing the sash relative to the frame with the at least one elongate lineal tilt latch actuator.
